(19) United States
(12) Patent Application Publication
(10) Pub. No.: US 2017/0355893 A1
(43) Pub. Date: Dec. 14, 2017

(54) COMPOSITIONS AND USES OF CIS-1,1,1,4,4,4-HEXAFLUORO-2-BUTENE AND CYCLOPENTANE

(71) Applicant: HONEYWELL INTERNATIONAL INC., MORRIS PLAINS, NJ (US)

(72) Inventors: Yiu K. Ling, Amherst, NY (US); Mary C. Bogdan, Buffalo, NY (US); Bin Yu, Tonawanda, NY (US); David J. Wilkes, Tonawanda, NY (US); David J. Williams, East Amherst, NY (US)

(21) Appl. No.: 15/606,582

(22) Filed: May 26, 2017

Related U.S. Application Data
(63) Continuation-in-part of application No. 15/431,114, filed on Feb. 13, 2017.
Application No. 15/431,114 is a continuation-in-part of application No. 15/209,306, filed on Jul. 13, 2016.
Application No. 15/431,114 is a continuation of application No. 12/968,506, filed on Dec. 15, 2010, now abandoned.
Application No. 15/209,306 is a continuation of application No. 12/968,506, filed on Dec. 15, 2010, now abandoned.
(60) Provisional application No. 61/287,033, filed on Dec. 16, 2009.

(51) Int. Cl. C09K 3/30; C11D 7/50; A23L 27/10; C11D 3/24; C11D 7/26; C08J 9/12; C11D 7/24; C08G 18/76; A01N 27/00; C08G 18/40; C08G 18/08; A23L 27/20; C09K 5/04; C09K 21/08; C10M 131/04; A62D 1/00; C11D 7/02; A01N 59/00; C08J 9/14; A01N 29/02; C11B 9/02; C10M 171/00; A01N 35/02; A01N 31/02

(52) U.S. Cl. CPC C09K 3/30; A01N 31/02; C11D 7/5018; A23L 27/11; C11D 3/245; C11D 7/263; C08J 9/127; C11D 7/24; C08G 18/7664; A01N 27/00; C08G 18/4018; C08G 18/14; A23L 27/202; C11D 7/264; C09K 5/044; C09K 21/08; C10M 131/04; A62D 1/0057; C11D 7/02; C09K 5/045; A01N 59/00; C08J 9/149; C08J 9/144; A01N 29/02; C08J 9/146; C11B 9/025; C10M 171/008; A01N 35/02; A23V 2002/00; A01N 2300/00; C08J 2203/182; C08J 2375/08; C08J 2203/184; C09K 2205/12; C09K 2205/112; C09K 2205/22; C10M 2211/022; C10N 2240/30

(57) ABSTRACT

Disclosed is a thermoset, thermal insulating foams having desirable and unexpectedly low thermal conductivity, and to compositions, method and systems which use and/or are used to make such foams comprising: (a) providing thermosetting foam forming component and a blowing agent for forming predominantly closed cells in the foam, wherein the blowing agent comprises: (i) cis-1,1,1,4,4,4-hexafluoro-2-butene (HFO-1336mzzm(Z)) and cyclopentane, with the HFO-1336mzzm(Z) and cyclopentane in the blowing agent together comprising at least about 50% by weight of the total of all components in the blowing agent and (ii) the weight ratio of HFO-1336mzzm(Z) to cyclopentane in the blowing agent is from about 45:55 to less than 68:32 and (b) forming foam from said provided foamable composition.

### CROSS-REFERENCE TO RELATED APPLICATION

This application is a continuation-in-part of each of U.S. application Ser. No. 15/431,114, filed Feb. 13, 2017 and U.S. application Ser. No. 15/209,306, filed Jul. 13, 2016, each of which in turn is a continuation of U.S. application Ser. No. 12/968,506, filed Dec. 15, 2010, (abandoned), which in turn claims benefit of U.S. Provisional Patent Application Ser. No. 61/287,033 filed Dec. 16, 2009. The disclosure of each application mentioned in this paragraph is hereby incorporated herein by reference.

### FIELD OF THE INVENTION

This invention relates to thermal insulating foams for panel and pour-in-place foam applications and to compositions, methods and systems which use and/or are used to make such foams, and in particular to foams having one or more improved properties, including particularly improved certain dimensional stability properties, and to compositions, methods and systems for making and using same.

### BACKGROUND OF THE INVENTION

Polymeric or plastic foams in general have numerous and widely varying applications and can be formed from a wide variety of materials. For example, the material which forms the matrix, or solid portion, of the foam can be a thermoplastic or a thermosetting material, and each of such materials can be used and has been used in a wide variety of applications. One such application is to provide thermal insulation.

One desirable property for thermal insulating applications is to provide the foam with a resistance to the flow of heat that is as high as possible. This property is frequently measured in terms of the thermal conductivity of the foam, and the resistance to the flow of heat generally increases as the thermal conductivity of the foam decreases.

The blowing agent used for the formation of foam materials can have an impact on one or more properties of the foam that is produced. It has been noted, for example, that blowing agent composition which are pure single components have an advantage in that the make-up of the composition will not change during its application in the foaming process, and that this advantage is generally shared by blowing agents which are azeotropic or azeotrope-like mixtures of compositions. See WO 2008/134061—Robin, which teaches that azeotropic compositions comprising from 1 to 32% by weight of cyclopentane and from 68% to 99% of cis-1,1,1,4,4,4-hexafluoro-2-butene (Z—HFO-1336mzzm) may be used for several applications, including heat transfer compositions, flame suppression agents and blowing agents for thermoplastic and thermosetting foams. The Robin patent teaches that using compositions which are not azeotropic or azeotrope-like could detrimentally affect processing or cause poor performance, and therefore teaches away from using this combination of components outside of the above-noted ranges.

It has been known that certain thermosetting foams can be formed using cis-1,1,1,4,4,4-hexafluoro-2-butene (HFO-1336mzzm(Z) or cis-1336mzzm) as one component of the blowing agent. See for example, Japanese laid open patent application H-179043. However, H-179043 does not disclose the use of this material, either alone or in combination, for use in connection with the formation of panel foams or pour-in-place foams, nor does it indicate or suggest that a highly desirable low thermal conductivity while at the same time achieving high dimensional stability can be achieved by judicious selection of the amount of cis-1336mzzm to be used in combination with a specific amount or type of co-blowing agent.

### SUMMARY OF THE INVENTION

This invention relates to thermoset, thermal insulating panel and pour-in-place foams having desirable and unexpectedly low thermal conductivity, and to compositions, method and systems which use and/or are used to make such foams. As used herein, the term “panel” is meant to mean foam insulation produced by a continuous or discontinuous process in the form of boards or slabs with a facer material, such as but not limited to multilayer film, aluminum foil, roofing felt, metal, wood, gypsum wall board, and the like attached to opposite sides to produce a sandwich-like configuration.

One aspect of the invention provides a method of making thermoset, thermal insulation foams, and in particular insulating panel or pour-in-place foams, comprising: (a) providing foamable composition comprising a thermosetting foam forming component, preferably a polyurethane foam forming component, and a blowing agent for forming predominantly closed cells in the foam, wherein the blowing agent comprises: (i) cis-1,1,1,4,4,4-hexafluoro-2-butene (HFO-1336mzzm(Z)) and cyclopentane, with the HFO-1336mzzm(Z) and cyclopentane in the blowing agent together comprising at least about 50% by weight of the total of all components in the blowing agent, preferably at least about 70% by weight, more preferable from about 80% to about 100% by weight; and (ii) the weight ratio of HFO-1336mzzm(Z) to cyclopentane in the blowing agent is from about 45:55 to less than 68:32, preferably from about 45:55 to about 65:35 and even more preferably from about 50:50 to about 60:40; and (b) forming foam, preferably panel foam or pour-in-place foam, from said provided foamable composition.

The term “polyurethane foam” used herein means a rigid or semi-rigid cellular material with a predominately closed cell structure based on polyurethane, with such material being useful as thermal insulation in preferred embodiments. This term “polyurethane foam” is understood to include polyisocyanurate foam, which is understood to mean a rigid or semi-rigid cellular plastic with a substantially closed cell structure based on polyisocyanurate. The term “polyurethane foam” is further understood to include rigid or semi-rigid cellular plastic insulation which contains both polyurethane and polyisocyanurate structures in various proportions, with such material being useful for thermal insulation in preferred embodiments.

As applicants use the term herein, “about” is intended to encompass ordinary variability in the measurement of the indicated quantity. Applicants have unexpectedly found that when the HFO-1336mzzm(Z) and cyclopentane are present in the blowing agent in the amounts and in the relative ratios described herein, particularly and preferably when used in panel foam formulations or pour-in-place foam formulations, a highly desirable but unexpectedly high level of dimensional stability is achieved, preferably while also achieving desirably high levels of resistance to heat flow. As those skilled in the art will appreciate, achieving the level of dimensional stability, while preferably also achieving low levels of thermal conductivity, achieved according to the present invention are extremely valuable, difficult to achieve, and not predictable, especially in connection with panel foam and pour-in-place foam.

Applicants have found that substantial and unexpected advantage can be achieved by utilizing in thermosetting foam applications blowing agent compositions which comprise from about 45 wt. % to less than 68 wt % of cis-1,1,1,4,4,4-hexafluoro-2-butene (Z—HFO-1336mzzm) and from greater than 32 wt % to about 55 wt % of cyclopentane, more preferably from about 45 wt. % to about 65 wt % Z—HFO-1336mzzm and from greater about 35 wt % to about 55 wt % of cyclopentane, and even more preferably from about 50 wt. % to about 60 wt % Z—HFO-1336mzzm and from greater about 40 wt % to about 50 wt % of cyclopentane. As used herein, the term “cyclopentane” means cyclopentane having a purity of 95% or greater. As those skilled in the art appreciate, cyclopentane with a purity of about 95% is known as reagent grade and is used in preferred embodiments of the present invention. The use of technical grade cyclopentane, that is, cyclopentane having about 70% purity, is also preferred.

Applicants have also found that substantial and unexpected advantage can be achieved by utilizing blowing agent compositions in thermosetting foam applications which comprise, and preferably consists essentially of and more preferably consists of, from about 2 wt % to about 10 wt % of water, from about 45 wt. % to less than 68 wt % of cis-1,1,1,4,4,4-hexafluoro-2-butene (Z—HFO-1336mzzm) and from greater than 32 wt % to about 55 wt % of cyclopentane. In preferred embodiments, the blowing agent comprises, and preferably consists essentially of and more preferably consists of, from about 3.5 wt % to about 5.5 wt % of water, 45 wt. % to about 65 wt % Z—HFO-1336mzzm and from greater about 35 wt % to about 55 wt % of cyclopentane.

The blowing agent compositions of the present invention for use in thermosetting foam applications preferably consist essentially of from about 45 wt. % to less than 68 wt % of cis-1,1,1,4,4,4-hexafluoro-2-butene (Z—HFO-1336mzzm) and from greater than 32 wt % to about 55 wt % of cyclopentane, more preferably from about 45 wt. % to about 65 wt % Z—HFO-1336mzzm and from greater about 35 wt % to about 56 wt % of cyclopentane, and even more preferably from about 50 wt. % to about 60 wt % Z—HFO-1336mzzm and from greater about 40 wt % to about 50 wt % of cyclopentane.

The blowing agent compositions of the present invention for use in thermosetting foam applications preferably consist of from about 45 wt. % to less than 68 wt % of cis-1,1,1,4,4,4-hexafluoro-2-butene (Z—HFO-1336mzzm) and from greater than 32 wt % to about 55 wt % of cyclopentane, more preferably from about 45 wt. % to about 65 wt % Z—HFO-1336mzzm and from greater about 35 wt % to about 56 wt % of cyclopentane, and even more preferably from about 50 wt. % to about 60 wt % Z—HFO-1336mzzm and from greater about 40 wt % to about 50 wt % of cyclopentane.

In preferred embodiments, the invention provides a method of making thermoset, thermal insulation panel foams, comprising: (a) providing foamable composition comprising a thermosetting, polyurethane foam forming component, and a blowing agent for forming predominantly closed cells in the foam, wherein the blowing agent comprises: (i) cis-1,1,1,4,4,4-hexafluoro-2-butene (HFO-1336mzzm(Z)) and cyclopentane, with the HFO-1336mzzm(Z) and cyclopentane in the blowing agent together comprising at least about 70% by weight of the combination of HFO-1336mzzm(Z) and cyclopentane based on all the components in the blowing agent, and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40; and forming said foamable composition into a panel.

In preferred embodiments, the invention provides a method of making thermoset, thermal insulation pour-in-place foams, comprising: (a) providing foamable composition comprising a thermosetting, polyurethane foam forming component, and a blowing agent for forming predominantly closed cells in the foam, wherein the blowing agent comprises: (i) cis-1,1,1,4,4,4-hexafluoro-2-butene (HFO-1336mzzm(Z)) and cyclopentane, with the HFO-1336mzzm(Z) and cyclopentane in the blowing agent together comprising blowing agent comprises at least about 70% by weight of the combination of HFO-1336mzzm(Z) and cyclopentane based on all the components in the blowing agent, and the weight ratio of said HFO-1336mzzm(Z) to said cyclopentane in the blowing agent is from about from about 45:55 to less than 68:32, preferably from about 45:55 to about 65:35 and even more preferably from about 50:50 to about 60:40; and pouring said foamable composition into a poured-in-place foam.

In preferred embodiments, the blowing agent in each of the above-noted preferred methods comprises at least about 80% by weight of the combination of HFO-1336mzzm(Z) and cyclopentane based on all the components in the blowing agent, and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

In preferred embodiments, the blowing agent in each of the above-noted preferred methods comprises at least about 90% by weight of the combination of HFO-1336mzzm(Z) and cyclopentane based on all the components in the blowing agent, and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

In preferred embodiments, the blowing agent in each of the above-noted preferred methods comprises at least about 95% by weight of the combination of HFO-1336mzzm(Z) and cyclopentane based on all the components in the blowing agent, and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

In preferred embodiments, the blowing agent in each of the above-noted preferred methods consists essentially of a combination of HFO-1336mzzm(Z) and cyclopentane and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

In preferred embodiments, the blowing agent in each of the above-noted preferred methods consists of a combination of HFO-1336mzzm(Z) and cyclopentane, and the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

The present invention also provides closed cell thermal insulating foam having a gas in at least 50% by number of the cells in which the gas in cells comprise at least about 60 mole %, more preferably at least about 70 mole %, and even more preferably at least about 80 mole % of HFO-1336mzzm(Z)/cyclopentane, where “HFO-1336mzzm(Z)/cyclopentane” refers to the moles of each of these components taken together. In each of such embodiments, it is preferred that the mole ratio of HFO-1336mzzm(Z):cyclopentane in the gas in the cell is from 1:1 to about 1:3.

The present invention also provides closed cell thermal insulating foam having a gas in substantially all of the cells, in which the gas in cells comprise at least about 60 mole %, more preferably at least about 70 mole %, and even more preferably at least about 80 mole % of HFO-1336mzzm(Z)/cyclopentane, where “HFO-1336mzzm(Z)/cyclopentane” refers to the moles of each of these components taken together. In each of such embodiments, it is preferred that the mole ratio of HFO-1336mzzm(Z):cyclopentane in the gas in the cell is from 1:1 to about 1:3.

In preferred embodiments, which applicants have also found that substantial and unexpected advantage can be achieved, the gas in the closed cell of the thermosetting foam comprises, and preferably consists essentially of and more preferably consists of about 5 mole % to about 45 mole % CO₂, from about 15 mole % to about 50 mole % Z—HFO-1336mzzm, and from about 25 mole % to about 70 mole % cyclopentane.

In preferred embodiments, which applicants have also found that substantial and unexpected advantage can be achieved, the gas in the closed cell of the thermosetting foam comprises, and preferably consists essentially of and more preferably consists of from about 10 mole % to about 45 mole % CO₂, from about 15 mole % to about 45 mole % Z—HFO-1336mzzm, and from about 30 mole % to about 70 mole % cyclopentane.

In preferred embodiments, which applicants have also found that substantial and unexpected advantage can be achieved, the gas in the closed cell of the thermosetting foam comprises, and preferably consists essentially of and more preferably consists of from about 10 mole % to about 35 mole % CO₂, from about 15 mole % to about 45 mole % Z—HFO-1336mzzm, and from about 30 mole % to about 70 mole % cyclopentane.

In preferred embodiments, which applicants have also found that substantial and unexpected advantage can be achieved, the gas in the closed cell of the thermosetting foam comprises, and preferably consists essentially of and more preferably consists of from about 15 mole % to about 30 mole % CO₂, from about 20 mole % to about 40 mole % Z—HFO-1336mzzm, and from about 40 mole % to about 60 mole % cyclopentane.

In preferred embodiments, the blowing agent comprises, and preferably consists essentially of and more preferably consists of, from about 3.5 wt % to about 5.5 wt % of water, and even more preferably from about 50 wt. % to about 60 wt % Z—HFO-1336mzzm and from greater about 40 wt % to about 50 wt % of cyclopentane.

In a preferred embodiment of the present invention, the step of forming said foam comprises reacting a thermosetting foam forming component, preferably a polyurethane foam forming component, to form a thermoset matrix of polymeric material, preferably a matrix of polyurethane, and predominantly closed cells in the polymeric matrix. In such embodiments, the reacting step comprises including in said blowing agent composition a component which reacts with at least a portion of said thermosetting foam forming component, preferably with at least a portion of said polyurethane foam forming component, to produce gaseous CO₂, such component in preferred embodiments comprising water.

Another aspect of the invention provides thermoset, thermal insulating foam, preferably formed as a panel or by pour-in-place foam, comprising: (a) a thermoset matrix of polymeric material, preferably polyurethane, and predominantly closed cells in said matrix; and (b) gaseous blowing agent contained in said cells, wherein the gaseous material in said closed cells comprises HFO-1336mzzm(Z) and cyclopentane and wherein said HFO-1336mzzm(Z) and cyclopentane together comprise at least about 50 weight percent, and even more preferably at least about 75% by weight, of the gaseous components in the cell and wherein said foam has dimensional stability as measured at least one of, but preferably at each of, 90° C. and ambient humidity and at 70° C. and a relative humidity of 95% of not greater than about 5%, and even more preferably of not greater than about 4.5%, measured after exposure to said temperature and humidity conditions for 28 days in accordance with ASTM D2126-09.

Another aspect of the invention provides thermoset, thermal insulating foam, preferably formed as a panel or by pour-in-place foam, comprising: (a) a thermoset matrix of polymeric material, preferably polyurethane, and predominantly closed cells in said matrix; and (b) gaseous blowing agent contained in said cells, wherein the gaseous material in said closed cells comprises at least about 75% by mole, preferably at least about 85% by mole, more preferably consists essentially of, and even more preferably consist of, the combination of CO₂, HFO-1336mzzm(Z) based on all of the gaseous components in the cell and wherein said foam has dimensional stability as measured at least one of, but preferably at each of, 90° C. and ambient humidity and at 70° C. and a relative humidity of 95% of not greater than about 5%, and even more preferably of not greater than about 4.5%, measured after exposure to said temperature and humidity conditions for 28 days in accordance with ASTM D2126-09.

Another aspect of the invention provides thermoset, thermal insulating foam, preferably formed as a panel or by pour-in-place foaming, comprising: (a) a thermoset matrix of polymeric material, preferably polyurethane, and predominantly closed cells in said matrix; and (b) gaseous blowing agent contained in said cells, wherein the gaseous material in said closed cells comprises HFO-1336mzzm(Z) and cyclopentane and wherein said HFO-1336mzzm(Z) and cyclopentane together comprise at least about 50 weight percent, and even more preferably at least about 75% by weight of the gaseous components in the cell and wherein said foam has dimensional stability as measured at 90° C. and ambient humidity conditions and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

Another aspect of the invention provides thermoset, thermal insulating foam, preferably formed as a panel or by pour-in-place foam, comprising: (a) a thermoset matrix of polymeric material, preferably polyurethane, and predominantly closed cells in said matrix; and (b) gaseous blowing agent contained in said cells, wherein the gaseous material in said closed cells comprises at least about 75% by mole, preferably at least about 85% by mole, more preferably consists essentially of, and even more preferably consist of, the combination of CO₂, HFO-1336mzzm(Z) based on all of the gaseous components in the cell and wherein said foam has dimensional stability as measured at 90° C. and ambient humidity conditions and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

Another aspect of the invention provides thermoset, thermal insulating foam, preferably formed as a panel, comprising: (a) a thermoset matrix of polymeric material, preferably polyurethane, and predominantly closed cells in said matrix; and (b) gaseous blowing agent contained in said cells, wherein the gaseous material in said closed cells comprises HFO-1336mzzm(Z) and cyclopentane and wherein said HFO-1336mzzm(Z) and cyclopentane together comprise at least about 50 weight percent, and even more preferably at least about 75% by weight of the gaseous components in the cell and wherein said foam has dimensional stability as measured at 90° C. and ambient humidity and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

Another aspect of the invention provides thermoset, thermal insulating foam, preferably formed by pour-in-place foaming, comprising: (a) a thermoset matrix of polymeric material, preferably polyurethane, and predominantly closed cells in said matrix; and (b) gaseous blowing agent contained in said cells, wherein the gaseous material in said closed cells comprises HFO-1336mzzm(Z) and cyclopentane and wherein said HFO-1336mzzm(Z) and cyclopentane together comprise at least about 50 weight percent, and even more preferably at least about 75% by weight of the gaseous components in the cell and wherein said foam has dimensional stability as measured at 90° C. and ambient humidity and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

Another aspect of the invention provides thermoset, thermal insulating foam, preferably formed by pour-in-place foaming, comprising: (a) a thermoset matrix of polymeric material, preferably polyurethane, and predominantly closed cells in said matrix; and (b) gaseous blowing agent contained in said cells, wherein the gaseous material in said closed cells comprises at least about 75% by mole, preferably at least about 85% by mole, more preferably consists essentially of, and even more preferably consist of, the combination of CO₂, HFO-1336mzzm(Z) based on all of the gaseous components in the cell and wherein said foam has dimensional stability as measured at 90° C. and ambient humidity and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

It should be noted that it would be common and expected for a product designated as HFO-1336mzzm(Z) to include a minor percentage, for example about 10 ppm up to about 2 wt. % of other components, including particularly HFO-1336mzzm(E). When used herein, the term “consisting essentially of HFO-1336mzzm(Z)” is intended to generally include such compositions. The terms “consist of” and “consisting of” as used herein, do not include such other amount of components but could include trace or contamination levels of other components.

Another aspect of the invention provides thermoset, thermal insulating foam formed as a panel foaming, comprising: (a) a thermoset matrix of polyurethane and predominantly closed cells in said matrix; and (b) gaseous blowing agent contained in said cells, wherein the gaseous material in said closed cells comprises, consists essentially of HFO-1336mzzm(Z) and cyclopentane and wherein the mole ratio of said HFO-1336mzzm(Z) to said cyclopentane is from about 26:74 to about 44:56, and even more preferably from about 30:70 to about 40:60 and wherein said foam has a has dimensional stability as measured at 90° C. at ambient humidity and at 70° C. and a relative humidity of 95% of not greater than about 5%, and even more preferably of not greater than about 4.5% and wherein said foam has an initial k-factor (also called lambda) as measured at −6.7° C. of not greater than 21 mW/mK.

All of the embodiments of the invention described herein may, if desired, be obtained in a substantially purified form, such that these embodiments preferably consist of only the actual components designated, other than minor (e.g., ppm) impurities.

One embodiment of the present invention provides foamable compositions. As is known to those skilled in the art, foamable compositions generally include one or more components capable of forming foam. As used herein, the term “foamable composition” refers to a combination of components which are capable of forming a foam structure, preferably a generally cellular foam structure.

### DESCRIPTION OF THE DRAWINGS

FIG. 1 is a plot of dimensional stability as a function of the weight percent cyclopentane based on 1233zd and cyclopentane in the blowing agent based on the data from the Examples.

FIG. 2 is a plot of thermal conductivity as a function of wt % cyclopentane 1233zd and cyclopentane in the blowing agent based on the data from the Examples.

### DETAILED DESCRIPTION OF PREFERRED EMBODIMENTS

One aspect of the present invention relates to thermal insulating foams, preferably and particularly thermal insulating panel foams and thermal insulating pour-in-place foams, that have uses in a wide variety of insulation applications. The foams of the present invention formed from pour-in-place foam formulations and by pour-in-place foaming are preferably used in applications which include appliance foams, such as refrigerators, freezers and the like, and pipe insulation. The foams of the present invention formed from panel foam formulations and by panel forming operations are preferably used in applications which include roofing and roofing panels, building envelope insulation, refrigerated transport insulation, pipe insulation, tank insulation, cryogenic gas container and vessel insulation, including LNG, LPG, nitrogen and other cryogenic gas shipping tanks and transporters. Panel foams can be produced using either continuous or discontinuous manufacturing processes.

Two important factors in the large-scale commercial acceptance of such foams, including rigid polyurethane applications, are the insulating value of the foam, typically as measured by thermal conductivity (k-factor, lambda) and the dimensional stability as measure by change in the volume of the foam. The blowing agent used in the formation of such foams is important in this regard since either the blowing agent component itself (as in the case of physical blowing agent) or the gaseous reaction product formed from the blowing agent component (in the case of chemical blowing agent) is typically encapsulated or entrained in the closed cell structure of the foam, preferably the rigid foam, and are the major contributor(s) to the thermal conductivity properties of foam, particularly to the rigid urethane foams.

The k-factor of a foam is defined as the rate of transfer of heat energy by conduction through a unit area of a unit thickness of homogenous material in unit time where there is a specific temperature differential perpendicularly across the two surfaces of the material.

The dimensional stability of a foam is defined as the change in the volume of the foam after being subject to certain test conditions. One such test condition is wherein the foam is tested by ASTM D-2126-09, which specifies that precisely measured samples be placed in an environmental chamber at 90° C. and ambient relative humidity (sometimes referred to herein as Hot/Dry Stability). Another such test condition is is wherein the foam is tested by ASTM D-2126-09, which specifies that precisely measured samples be placed in an environmental chamber at 75° C. and 95% relative humidity (sometimes referred to herein as Hot/Humid Stability).

An advantageous feature of utility of closed-cell foams, including particularly polyurethane-type foams, is the ability to simultaneously possess a high level of dimensional stability (that is, low percentage volume change) as measured by Hot/Dry stability and by Hot/Humid stability, and preferably while also achieving excellent thermal insulating properties. Applicants have found that it is possible to achieve dimensional stability levels for each of Dry/Hot stability and Wet/Hot stability of less than 5%, and even more preferably less than about 4.5% when the blowing agent is comprised of HFO-1336mzzm(Z) and cyclopentane in the amounts and relative proportions described herein. More particularly, applicants have unexpectedly found that blowing agent compositions which contain cyclopentane:HFO-1336mzzm(Z) ratios less than 32:68 (or relative amounts of cyclopentane less than 32 wt %) tend to exhibit Wet/Hot stability much higher that desired, including at levels higher than 5% volume change, while at the same time blowing agent compositions which contain cyclopentane:1336mzzm(Z) ratios greater than about 60:40 (or relative amounts of cyclopentane greater than about 60 wt %) tend to exhibit Dry/Hot stability much higher than desired, including at levels higher than 5% volume change.

In addition, applicants have also found that the foams made in accordance with present invention have acceptably low k-values for thermal insulation, especially at relatively cold temperatures, such as when measured at −6.7° C.

The panel foams of the present invention preferably have an initial k-factor (also sometimes referred to herein as “initial lambda”) as measured at 12.8° C. of not greater than 23 mW/mK, and even more preferably of not greater than about 22 mW/mK, while having Dry/Hot and Wet/Hot stability of not greater than about 5%, and even more preferably not greater than about 4.5%. Applicants have found that such low k-factors and high stability levels for panel foams can be achieved by utilizing the combination of HFO-1336mzzm(Z) and cyclopentane in the blowing agent in the amounts and relative ratios specified herein, but in particular where the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

The pour-in-place foams of the present invention preferably have an initial k-factor (also sometimes referred to herein as “initial lambda”) as measured at 12.8° C. of not greater than 23 mW/mK, and even more preferably of not greater than about 22 mW/mK, while having Dry/Hot and Wet/Hot stability of not greater than about 5%, and even more preferably not greater than about 4.5%. Applicants have found that such low k-factors and high stability levels for panel foams can be achieved by utilizing the combination of HFO-1336mzzm(Z) and cyclopentane in the blowing agent in the amounts and relative ratios specified herein, but in particular where the weight ratio of said HFO-1336mzzm(Z) to said cyclopentane in the blowing agent is from about 45:55 to less than 68:32, preferably from about 45:55 to about 65:35 and even more preferably from about 50:50 to about 60:40.

It is generally preferred that the blowing agent of the present invention comprises at least about 70% by weight of the combination of HFO-1336mzzm(Z) and cyclopentane, more preferably at least about 80% by weight, and even more preferably at least about 95% by weight. To the extent other co-blowing agents are included in the blowing agent, it is contemplated that those skilled in the art will be able, in view of the teachings contained herein, to select the specific co-blowing agent(s) and the amount(s) to achieve the result desired for any particular application.

By way of example, possible co-blowing agents which are believed to be generally applicable for use according to the present invention include by way of example chlorocarbons, fluorocarbons (CFCs), hydrochlorofluorocarbons (HCFC), hydrofluorocarbons (HFC), hydrohaloolefins (HFO), hydrocarbons, ethers, esters, aldehydes, ketones, acetals, organic acids, atmospheric gases, or other materials that generate gas, for example CO2, through decomposition or chemical reaction, and mixtures of two or more of these.

For those applications in which an HFC co-blowing agent is preferred for use, preferred HFCs include HFC-245fa (CHF2CH2CF3), HFC-365mfc (CH3CF2CH2CF3), HFC-227ea (CF3CHFCF3), HFC-134a (CH2FCF3), HFC-152a (CH3CHF2) and combinations of these. In highly preferred embodiments in which the co-blowing agent is an HFC, the HFC co-blowing agent is preferably selected from HFC-245fa (CHF2CH2CF3), HFC-365mfc (CH3CF2CH2CF3), HFC-227ea (CF3CHFCF3), HFC-134a (CH2FCF3), HFC-152a (CH3CHF2) and combinations of these.

For those applications in which an HFO co-blowing agent is preferred for use, preferred HFOs include, HFO-1234ze(E) (trans-CF3CH═CHF), HFO-1234ze(Z) (cis-CF3CH═CHF), HFO-1234yf (CF3-CF═CH2) HFO-1233zd(E) (trans-CF3CH═CHCl), HFO-1233zd(Z) (cis-CF3CH═CHCl), HFO-1233xf (CH2═CCl—CF3), HFO-1336mzzm(E) (trans-CF3CH═CH—CF3), trans-1,2-dichloroethylene and combinations of these. The hydrohaloolefin co-blowing agent preferably comprises at least one halooalkene such as a fluoroalkene or fluorochloroalkene containing from 3 to 4 carbon atoms and at least one carbon-carbon double bond. Preferred hydrohaloolefins non-exclusively include trifluoropropenes, tetrafluoropropenes such as HFO-1234ze(E), pentafluoropropenes such as HFO-1225, chlorotrifloropropenes such as HFO-1233zd(E), HFO-1233xf, chlorodifluoropropenes, chlorotrifluoropropenes, chlorotetrafluoropropenes, trans-1,1,1,4,4,4-hexafluorobut-2-ene (HFO-1336mzzm(E)) and combinations of these. In highly preferred embodiments in which the co-blowing agent is an HFO, the HFO co-blowing agent is preferably selected from HFO-1234ze(E) (trans-CF3CH═CHF), HFO-1233zd(E) (trans-CF3CH═CHCl), HFO-1336mzzm(E) (trans-CF3CH═CH—CF3), trans-1,2-dichloroethylene, and combinations of these and any and all structural isomers, geometric isomers, or stereoisomers of each of these.

For those applications in which a hydrocarbon co-blowing agent is preferred for use, preferred hydrocarbons are C3-C6 hydrocarbons, including preferably propane, butane, isobutane, normal pentane, isopentane, cyclopentane, hexane and combinations of these. In highly preferred embodiments in which the co-blowing agent is a hydrocarbon, the hydrocarbon co-blowing agent is preferably selected from butane, isobutane, normal pentane, isopentane and combinations of these.

For those applications in which an ether or acetal co-blowing agent is preferred for use, preferred ethers include dimethyl ether, methylal, ethylal, with dimethyl ether and methylal being especially preferred.

For those applications in which an ester co-blowing agent is preferred for use, preferred esters include methyl formate, methyl acetate, ethyl acetate and combinations of these.

For those applications in which a ketone co-blowing agent is preferred for use, preferred ketones include acetone.

For those applications in which organic acid co-blowing agent is preferred for use, preferred organic acids include formic acid, acetic acid, polymeric acids, and mixtures of these.

In preferred embodiments, the co-blowing agent when present is selected from one or more of pentafluorobutane; pentafluoropropane; hexafluoropropane; heptafluoropropane; trans-1,2 dichloroethylene; methyl formate; 1-chloro-1,2,2,2-tetrafluoroethane; 1,1-dichloro-1-fluoroethane; 1,1,1,2-tetrafluoroethane; 1,1,2,2-tetrafluoroethane; 1-chloro 1,1-difluoroethane; 1,1,1,3,3-pentafluorobutane; 1,1,1,2,3,3,3-heptafluoropropane; trichlorofluoromethane; dichlorodifluoromethane; 1,1,1,3,3,3-hexafluoropropane; 1,1,1,2,3,3-hexafluoropropane; difluoromethane; difluoroethane; 1,1,1,3,3-pentafluoropropane; 1,1-difluoroethane; isobutane; normal pentane; isopentane; methylal (dimethoxymethane), 1-chloro-3,3,3-trifluoropropene (including cis isomers, trans isomers and all combinations thereof), 1,3,3,3-tetrafluoropropene (including cis isomers, trans isomers and all combinations thereof).

The relative amount of any of the above noted additional co-blowing agents, as well as any additional components which may be included in present compositions, can vary widely within the general broad scope of the present invention according to the particular application for the composition, and all such relative amounts are considered to be within the scope hereof.

As is known to those skilled in the art, it is convenient in many applications to provide the components for polyurethane or polyisocyanurate foams in pre-blended formulations. Most typically, the foam formulation is pre-blended into two components. The polyisocyanate and optional isocyanate compatible raw materials comprise the first component, commonly referred to as the “A” component. A polyol or mixture of polyols, surfactant, catalyst, blowing agent, and other isocyanate reactive and non-reactive components comprise the second component, commonly referred to as the “B” component. Accordingly, the foamable compositions, and preferably the polyurethane or polyisocyanurate foamable compositions, are readily prepared by bringing together the A and B side components either by hand mix for small preparations and, preferably, machine mix techniques to form the desired form, including blocks, slabs, panels and other items, pour-in-place applied foams, froths, and the like. Optionally, other ingredients such as fire retardants, colorants, auxiliary blowing agents, catalysts, surfactants and other polyols can be added to the mixing head or reaction site. Most conveniently, however, they are all incorporated into one B component.

In general, it is contemplated that the blowing agent of the present invention will be present in the polyol premix composition in an amount of from about 1 wt. % to about 30 wt. %, preferably from about 3 wt. % to about 25 wt. %, and more preferably from about 12 wt. % to about 25 wt. %, by weight of the polyol premix composition. In preferred embodiments, the blowing agent is present in the foamable composition (e.g., polyol premix plus isocyanate) in amount of from about 5 wt. % to about 20 wt. %, and more preferably from about 5 wt. % to about 15 wt. %, and even more preferably from about 5 wt. % to about 10 wt. %.

The preferred compositions of the present invention are environmentally acceptable and do not to contribute to the depletion of the earth's stratospheric ozone layer. The blowing agent compositions of the present invention preferably have no substantial ozone depletion potential (ODP), preferably an ODP of not greater than about 0.5 and even more preferably an ODP of not greater than about 0.25, most preferably an ODP of not greater than about 0.1; and/or a global warming potential (GWP) of not greater than about 150, and even more preferably, a GWP of not greater than about 50.

As used herein, ODP is defined in the “Scientific Assessment of Ozone Depletion, 2002,” a report of the World Meteorological association, incorporated here by reference. As used herein, GWP is defined relative to that of carbon dioxide and over a 100 year time horizon, and defined in the same reference as for the ODP mentioned above.

Thus, the present invention includes methods, systems and composition in which a blowing agent contains HFO-1336mzzm(Z) and cyclopentane in the amounts and relative ratios described herein and/or the gas in the cells of the foam contains HFO-1336mzzm(Z) and cyclopentane in the amounts and relative ratios described herein, with one or more optional additional compounds which include, but are not limited to, other compounds which also act as blowing agents (hereinafter referred to for convenience but not by way of limitation as co-blowing agents), surfactants, polyols, catalysts, flame retardants, polymer modifiers, colorants, dyes, solubility enhancers, plasticizing agents, fillers, nucleating agents, viscosity reduction agents, vapor pressure modifiers, stabilizers, and the like. In certain preferred embodiments, dispersing agents, cell stabilizers, surfactants and other additives may also be incorporated into the blowing agent compositions of the present invention. Certain surfactants are optionally but preferably added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference. Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloro-propyl)phosphate, diammonium phosphate, various halogenated aromatic compounds, antimony oxide, aluminum trihydrate, polyvinyl chloride, and the like. With respect to nucleating agents, all known compounds and materials having nucleating functionality are available for use in the present invention.

Of course other compounds and/or components that modulate a particular property of the compositions (such as cost for example) may also be included in the present compositions, and the presence of all such compounds and components is within the broad scope of the invention.

One embodiment of the present invention relates to methods of forming foams, especially panel foams and pour-in-place foams, and preferably such foams made from polyurethane and polyisocyanurate. The methods generally comprise providing a blowing agent composition of the present inventions, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention.

In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives.

In certain preferred embodiments, the present methods and composition are used in connection with the production of panel foam and/or boardstock foam. Foamable compositions for such uses are preferably formulated so as to possess several important characteristics, including (1) relatively high degree of flame retardancy, which preferably allows the panel from the foam to pass various fire resistance tests (2) good adhesion to facing materials, and (3) good compressive and shear strength which allows the panel to meet the various mechanical tests required. In preferred embodiments, such foamable compositions are characterized by the use in the polyol premix of relatively high levels of polyester polyols, preferably such that from about 20% to about 100% by weight of the total polyol, or preferably from 50% to about 100% of the polyol is polyester polyol, or preferably from 80% to about 100% of the polyol is polyester polyol. In preferred embodiments, the present methods comprise forming a foamable composition as described according to any one of the embodiments herein into a foam panel or board by pouring the foamable composition onto a moving conveyor between top and/or bottom face sheets (which could be, for example, flexible facings like paper, roofing felt, aluminum foil, multilayer films or the like in the case of boardstock or rigid facings, like metal, wood, FRP, gypsum board, and the like in the case of panel foam). The foamable composition is then foamed by allowing the foamable composition to rise in a curing oven. For such continuous processes, the panels/boardstock is cut to length as it exits the curing oven. Another embodiment, which is generally batch or discontinuous, or semi-batch, comprises injecting the foamable composition of the invention between two facers in a mold and then foaming the composition in the mold. For such discontinuous panel/boardstock formation, the foamable composition is preferably allowed to rise and cure in the mold before demolding, which preferably comprises several minutes of cure time.

It is convenient in many applications to provide the components for polyurethane or polyisocyanurate foams in pre-blended formulations. Most typically, the foam formulation is pre-blended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, pour-in-place applied foams, froths, and the like. Optionally, other ingredients such as fire retardants, colorants, auxiliary blowing agents, and even other polyols can be added as one or more additional streams to the mix head or reaction site. Most preferably, however, they are all incorporated into one B-component as described above.

In certain embodiments, the one or more components capable of forming foam comprise a thermosetting composition capable of forming foam and/or foamable compositions. Examples of thermosetting compositions include polyurethane and polyisocyanurate foam compositions, epoxy and also phenolic foam compositions. This reaction and foaming process may be enhanced through the use of various additives such as catalysts and surfactant materials that serve to control and adjust cell size and to stabilize the foam structure during formation. Furthermore, is contemplated that any one or more of the additional components described herein with respect to the blowing agent compositions of the present invention could be incorporated into the foamable composition of the present invention. In such thermosetting foam embodiments, one or more of the present compositions are included as or part of a blowing agent in a foamable composition, or as a part of a two or more part foamable composition as described herein, which preferably includes one or more of the components capable of reacting and/or foaming under the proper conditions to form a foam or cellular structure.

It is contemplated that all presently known and available methods and systems for forming foam are readily adaptable for use in connection with the present invention. For example, the methods of the present invention generally require incorporating a blowing agent in accordance with the present invention into a foamable or foam forming composition and then foaming the composition, preferably by a step or series of steps which include causing volumetric expansion of the blowing agent in accordance with the present invention.

In general, it is contemplated that the presently used systems and devices for incorporation of blowing agent and for foaming are readily adaptable for use in accordance with the present invention. In fact, it is believed that one advantage of the present invention is the provision of an improved blowing agent which is generally compatible with existing foaming methods and systems.

Thus, it will be appreciated by those skilled in the art that the present invention comprises methods and systems for foaming all types of thermosetting foams. Thus, one aspect of the present invention is the use of the present blowing agents in connection conventional foaming equipment, such as polyurethane foaming equipment, at conventional processing conditions. The present methods therefore include polyol premix type operations, in-line blending type operations, third stream blowing agent addition, and blowing agent addition at the foam head.

It will be appreciated by those skilled in the art, especially in view of the disclosure contained herein, that the order and manner in which the blowing agent of the present invention is formed and/or added to the foamable composition does not generally affect the operability of the present invention. Moreover, the blowing agent can be introduced either directly or as part of a premix, which is then further added to other parts of the foamable composition.

Nevertheless, in certain embodiments, two or more components of the blowing agent are combined in advance and introduced together into the foamable composition, either directly or as part of premix which is then further added to other parts of the foamable composition.

Applicants have found that one advantage of the foams, and particularly thermoset foams such as polyurethane foams, in accordance with the present invention is the ability to achieve, preferably in connection with thermoset foam embodiments, exceptional thermal stability as measured by both Dry/Hot and Wet/Hot conditions, as well as in preferred embodiments excellent thermal performance, such as can be measured by the k-factor or lambda, particularly and preferably as measured at a temperature of 12.8° C. The foams in accordance with the present invention, in certain preferred embodiments, provide one or more exceptional features, characteristics and/or properties, including: thermal insulation efficiency, dimensional stability, compressive strength, aging of thermal insulation properties, all in addition to the low ozone depletion potential and low global warming potential associated with many of the preferred blowing agents of the present invention. In certain highly preferred embodiments, the present invention provides thermoset foam, including such foam formed into foam articles, which exhibit improved dimensional stability and/or thermal conductivity relative to foams made using a combination of HFO-1336mzzm(Z) and cyclopentane but outside the relative amounts described herein.

### EXAMPLES

### Comparative Examples C1, C2 and C3 and Examples 1 and 2

This example demonstrates the performance of a panel foam formed from a blowing agent consisting of a combination HFO-1336mzzm(Z), cyclopentane (reagent grade) and water, with HFO-1336mzzm(Z) and cyclopentane being present in relative ratios as indicated herein, to form rigid, thermal insulating panel foam of exceptional and unexpectedly good thermal stability, as well as exceptional and unexpectedly good thermal conductivity.

A representative polyurethane/polyisocyanurate foam formulation representative of that used in continuous boardstock or panel manufacture, which is generally referred to as a “panel foam” or “board stock foam” formulation (foam forming mixture) was provided. The foamable composition was formed by first forming a polyol blend consisting of commercial polyol(s), catalyst(s), surfactant(s), and blowing agent comprising HFO-1336mzzm(Z), water and cyclopentane (reagent grade) in the amounts indicated in table below. Panel forming techniques similar to representative of those described above for boardstock and panel foam were used for the foam forming process. The blowing agent components were added individually to the polyol blend, but one or more of the ingredients could have been pre-blended prior to introduction to the polyol blend, or it is possible that that one or more of the blowing agent components could have been added to the polyurethane portion before it is combined with the polyol blend.

The polyol blends and the polyurethane used to form the foamable composition, including the three comparative examples (C1, C2 and C3) and the examples according to the present invention (1 and 2) are described in Table A below.

TABLE A

| | EXAMPLE | | | | | | | | | |
|---|---|---|---|---|---|---|---|---|---|---|
| | C1 | | C2 | | 1 | | 2 | | C3 | |
| | Gm* | %* | Gm | % | Gm | % | Gm | % | Gm | % |
| Stepanol PS 2352, | 145.3 | 29.06 | 145.3 | 29.49 | 145.3 | 29.94 | 145.3 | 30.40 | 145.3 | 30.88 |
| polyester polyol | | | | | | | | | | |
| Catalysts | | | | | | | | | | |
| Dabco K15, | 4.36 | 0.87 | 4.36 | 0.88 | 4.36 | 0.9 | 4.36 | 0.91 | 4.36 | 0.93 |
| potassium octoate | | | | | | | | | | |
| in diethylene glycol | | | | | | | | | | |
| Polycat 5, tertiary | 0.87 | 0.17 | 0.87 | 0.18 | 0.87 | 0.18 | 0.87 | 0.18 | 0.87 | 0.18 |
| amine | | | | | | | | | | |
| Total Catalyst | 5.23 | 1.04 | 5.23 | 1.05 | 5.23 | 1.05 | 5.23 | 1.05 | 5.23 | 1.05 |
| Surfactant Niax | 3.63 | 0.73 | 3.63 | 0.74 | 3.63 | 0.75 | 3.63 | 0.76 | 3.63 | 0.77 |
| L-6900, non-hydro- | | | | | | | | | | |
| lysable silicone | | | | | | | | | | |
| copolymer | | | | | | | | | | |
| TMCP, flame | 21.79 | 4.36 | 21.79 | 4.42 | 21.79 | 4.49 | 21.79 | 4.56 | 21.79 | 4.63 |
| retardant | | | | | | | | | | |
| Blowing Agent | | | | | | | | | | |
| Water | 1.45 | 0.29 | 1.45 | 0.29 | 1.45 | 0.30 | 1.45 | 0.30 | 1.45 | 0.31 |
| HFO- | 51.3 | 10.26 | 38.5 | 7.81 | 25.7 | 5.30 | 12.8 | 2.68 | 0 | 0 |
| 1336mzzm(Z) | | | | | | | | | | |
| Cyclopentane | 0 | 0 | 5.5 | 1.12 | 10.9 | 2.25 | 16.4 | 3.43 | 21.9 | 4.65 |
| Lupranate | 271.3 | 54.26 | 271.3 | 55.06 | 271.3 | 55.90 | 271.3 | 56.77 | 271.3 | 57.65 |
| M20S, | | | | | | | | | | |
| isocyanate | | | | | | | | | | |
| TOTAL | 500 | 100 | 492.7 | 100 | 485.3 | 100 | 477.9 | 100 | 470.6 | 100 |
| BLOWING | | | | | | | | | | |
| AGENT % | | | | | | | | | | |
| AND RATIOS | | | | | | | | | | |
| Total Blowing | 52.75 | | 45.5 | | 38.05 | | 30.65 | | 23.85 | |
| Agent | | | | | | | | | | |
| Wt % BA | | 10.55 | | 9.22 | | 7.84 | | 6.41 | | 4.96 |
| in Foamable | | | | | | | | | | |
| Wt % Water | | 2.75 | | 3.19 | | 3.81 | | 4.73 | | 6.21 |
| in BA | | | | | | | | | | |
| Wt % Binary | | 97.25 | | 96.81 | | 96.19 | | 95.27 | | 93.79 |
| in BA** | | | | | | | | | | |

| | | | | | |
|---|---|---|---|---|---|
| 1336/cyclopentane | NA | 7:1 | 2.4:1 | 0.78:1 | 0 |
| wt ratio | | | | | |
| FOAM | | | | | |
| PROPERTIES | | | | | |
| LAMBDA | | | | | |
| Initial measured | 21.67 | 20.36 | 19.79 | 20.10 | 22.41 |
| @ −6.7° C., | | | | | |
| mW/mK | | | | | |
| Initial measured | 20.57 | 19.89 | 20.02 | 20.93 | 22.87 |
| @ 4.5° C., | | | | | |
| mW/mK | | | | | |
| Initial measured | 20.10 | 20.18 | 20.83 | 21.43 | 22.97 |
| @ 12.8° C., | | | | | |
| mW/mK | | | | | |
| Initial measured | 20.77 | 21.49 | 22.28 | 22.48 | 23.38 |
| @ 23.9° C., | | | | | |
| mW/mK | | | | | |
| STABILITY | | | | | |
| After 28 days | −0.73 | 0.01 | −1.01 | −1.11 | −0.8 |
| and measured | | | | | |
| @ −29° C. | | | | | |
| and ambient RH, | | | | | |
| vol change, % | | | | | |
| After 28 days | 3.08 | 4.71 | 3.78 | 4.99 | 6.02 |
| and measured | | | | | |
| @ 90° C. | | | | | |
| and ambient RH, | | | | | |
| vol change, % | | | | | |
| After 28 days | 6.91 | 6.8 | 5.4 | 3.82 | 3.58 |
| and measured | | | | | |
| @ 70° C. | | | | | |
| and 95% RH, | | | | | |
| vol change, % | | | | | |

*Grams of each component and wt % of each component in the foamable composition
**Binary refers to the combination of 1336mzzm(Z) and cyclopentane

Based on the foam formulation described above, on average each cell in the foam contains a gas having the following molar concentrations of components:

| | EXAMPLE | | | | |
|---|---|---|---|---|---|
| | C1 | C2 | 1 | 2 | C3 |
| | Mole % | Mole % | Mole % | Mole % | Mole % |
| CO2 | 20.5 | 20.5 | 20.50 | 20.5 | 20.5 |
| 1336 | 79.5 | 59.6 | 39.75 | 19.9 | 0 |
| Cyclopentane | 0 | 19.9 | 39.75 | 59.6 | 79.5 |

Those skilled in the art will appreciate that in Comparative Examples 1, 2 and 3 and in Examples 1 and 2 above the total moles of blowing agent in each examples has been maintained to about the same value. In addition, the amount of the isocyanate component has been adjusted compared to achieve the indicated Index for the foam formulation and to thereby make Examples 1 and 2 comparable to each other and to the comparative examples from a thermal insulating performance standpoint. As can be seen from the results reported above, each of the Example 1 and Example 2 formulations produced exceptional and unexpectedly superior foam performance in terms of dimensional stability and in terms of thermal insulating properties.

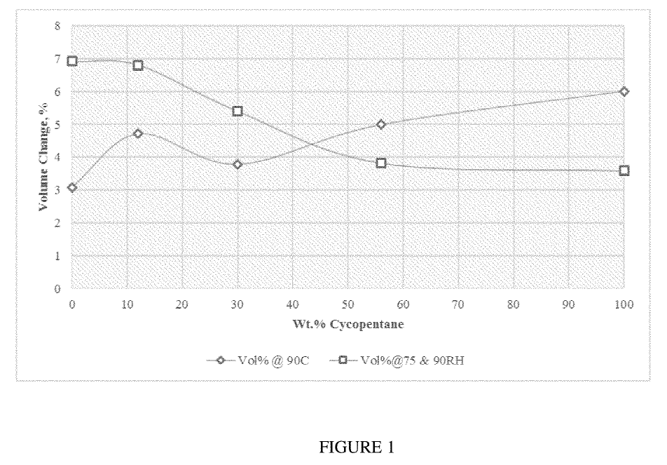

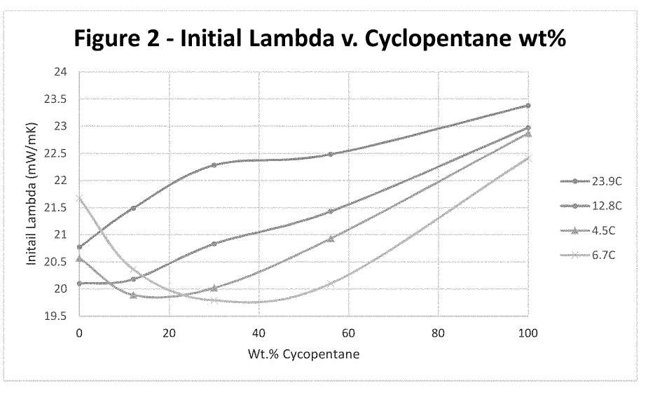

Each of these results is a significant and difficult to achieve performance advantage that is unexpected, is illustrated in FIGS. 1 and 2.

As can be seen from the results illustrated in FIG. 1, blowing agents, foamable compositions, foams and methods according to preferred aspects of the present invention result in an unexpected and highly advantageous thermosetting foam having both a desirably low value for both the volume % change when tested at 90° C. and ambient relative humidity and the volume % change when tested at 75° C. and 90% relative humidity. The ability to achieve low values for each of these important stability parameters unexpectedly occurs only in accordance with the preferred aspects of the present invention.

In addition, as can be seen from the results illustrated in FIG. 2, blowing agents, foamable compositions, foams and methods according to preferred aspects of the present invention result in an unexpected and highly advantageous thermal insulating capacity, as reflected by low K-values, especially when the foam is tested at temperatures of below about 5° C., and even more preferably when the foam is tested at each of −6.7° C. and 4.5° C. The ability to achieve such relatively low values for each of these important thermal insulating properties, which are especially important for producing energy efficient buildings, coolers and freezers, and other structures, unexpectedly occurs only in accordance with the preferred aspects of the present invention.

What is claimed is:

1. A method of making thermoset, thermal insulating foam, said foam being selected from panel and pour-in-place foams, said method comprising:
(a) providing a foamable composition comprising a thermosetting foam forming component and blowing agent for forming closed cells in the foam, wherein the blowing agent comprises: cis-1,1,1,4,4,4-hexafluoro-2-butene (HFO-1336mzzm(Z)) and cyclopentane, wherein (i) said HFO-1336mzzm(Z) and said cyclopentane in the blowing agent together comprise at least about 50% by weight of the total of all components in the blowing agent; and (ii) the weight ratio of HFO-1336mzzm(Z) to cyclopentane in the blowing agent is from about 45:55 to less than 68:32, and
(b) forming panel foam or pour-in-place foam from said provided foamable composition.

2. The method of claim 1 wherein said thermosetting foam components comprise a polyurethane foam forming component.

3. The method of claim 2 wherein said HFO-1336mzzm(Z) and said cyclopentane in the blowing agent together comprise at least about 70% by weight of the foam blowing agent.

4. The method of claim 2 wherein said HFO-1336mzzm(Z) and said cyclopentane in the blowing agent together comprise about 100% by weight of the foam blowing agent.

5. The method of claim 2 wherein said HFO-1336mzzm(Z) and said cyclopentane in the blowing agent are present in a weight ratio of from about 45:55 to about 65:35.

6. The method of claim 2 wherein said HFO-1336mzzm(Z) and said cyclopentane in the blowing agent are present in a weight ratio of from about 50:50 to about 60:40.

7. The method of claim 1 wherein said foam has an initial k-factor as measured at 12.5 C of not greater than 22 mW/mK.

8. The method of claim 1 wherein said foam has a Dry/Hot dimensional stability of not greater than about 5% and a Wet/Hot dimensional stability of not greater than about 5%.

9. The method of claim 1 wherein said foam has a Dry/Hot dimensional stability of not greater than about 4.5% and a Wet/Hot dimensional stability of not greater than about 4.5%.

10. A panel foam comprising the thermal insulating foam of claim 9.

11. A pour-in-place foam comprising the thermal insulating foam of claim 9.

12. A premix composition for forming a thermoset, thermal insulating panel foam or pour-in-place foam, said premix composition comprising: (a) at least one polyol; (b) catalyst; and (c) blowing agent, said blowing agent comprising: cis-1,1,1,4,4,4-hexafluoro-2-butene (HFO-1336mzzm(Z)) and cyclopentane, wherein (i) said HFO-1336mzzm(Z) and said cyclopentane in the blowing agent together comprise at least about 50% by weight of the total of all components in the blowing agent; and (ii) the weight ratio of HFO-1336mzzm(Z) to cyclopentane in the blowing agent is from about 45:55 to less than 68:32.

13. The premix composition of claim 12 comprising from about 5 wt % to about 25 wt % of said blowing agent.

14. The premix composition of claim 12 comprising from about 5 wt % to about 15 wt % of said blowing agent.

15. The premix composition of claim 12 comprising from about 5 wt % to about 10 wt % of said blowing agent.

16. The premix composition of claim 14 wherein said HFO-1336mzzm(Z) and said cyclopentane in the blowing agent together comprise at least about 70% by weight of the foam blowing agent.

17. The premix composition of claim 15 wherein said HFO-1336mzzm(Z) and said cyclopentane in the blowing agent together comprise at least about 70% by weight of the foam blowing agent.

18. The premix composition of claim 16 wherein said HFO-1336mzzm(Z) and said cyclopentane in the blowing agent are present in a weight ratio of from about 45:55 to about 65:35.

19. The premix composition of claim 16 wherein said HFO-1336mzzm(Z) and said cyclopentane in the blowing agent are present in a weight ratio of from about 50:50 to about 60:40.

20. The premix composition of claim 18 wherein said blowing agent consists essentially of HFO-1336mzzm(Z) and said cyclopentane.

21. The premix composition of claim 19 wherein said blowing agent consists essentially of HFO-1336mzzm(Z) and said cyclopentane.
